(19) United States
(12) Patent Application Publication
(10) Pub. No.: US 2008/0144205 A1
(43) Pub. Date: Jun. 19, 2008

(54) Overcoated replicated gold mirrors and methods for producing same

(75) Inventor: Jamie Knapp, Mendon, MA (US)

Correspondence Address: Brian F. Swienton, Newport Corporation, 1791 Deere Avenue, Irvine, CA, 92606, US

(73) Assignee: Newport Corporation, Irvine, CA (US)

(21) Appl. No.: 12/001,971

(22) Filed: Dec. 12, 2007

Related U.S. Application Data
(60) Provisional application No. 60/874,386, filed on Dec. 12, 2006.

(51) Int. Cl. G02B 5/08; B32B 37/02; B05D 5/06

(52) U.S. Cl. 359/884; 427/162; 156/280

(57) ABSTRACT

Overcoated replicated gold mirrors and methods for their formation are provided wherein the replicated gold mirrors include a reliably adherent overcoat layer that is applied at or below room temperature, is highly scratch resistant, and that does not detract from the high reflectivity of the underlying replicated gold mirror.

### BACKGROUND

At present, there are many useful applications, in various industries, for mirrors made with metallic coating materials. For example, aluminum mirrors, silver mirrors and gold mirrors are used, respectively, to reflect light having a wavelength within the ultraviolet (i.e., about 10 nm to about 400 nm), visible (i.e., about 400 nm to about 700 nm), and infrared (i.e., above 700 nm) ranges of the electromagnetic spectrum.

However, various problems exist with regard to such metallic-coated mirrors. In the case of those made from aluminum or silver, their reflective surfaces tend to tarnish over time due to oxidation, thus inhibiting their reflectivity. Unfortunately, it is nearly impossible to prevent such oxidation from occurring when aluminum or silver mirrors are used for their intended purposes. However, both aluminum and silver have high chemical reactivity whereby mirrors coated with these materials can be easily, reliably and inexpensively overcoated with materials (e.g.; silicon dioxide, aluminum oxide) to prevent tarnishing due to oxidation.

Gold-coated mirrors are not typically susceptible to oxidation, and thus do not tarnish like aluminum or silver-coated mirrors. However, in some applications, gold mirrors are exposed to harsh environmental conditions such that their surfaces routinely become contaminated with dust, dirt, and oils, and other contaminants. The presence of such contaminants can severely compromise the surface reflectivity of gold-coated mirrors, thereby degrading their performance. Moreover, precise cleaning of contaminated gold-coated mirror surfaces can cause surface scratching to occur, which also degrades the reflective quality of a gold-coated mirror.

In response thereto, a number of approaches for preventing scratching of gold-coated mirrors have been developed. For example, a protective overcoat may be applied to the gold-coated mirror. Generally, overcoating entails heating a gold-coated mirror to at least 300° C., lest the overcoat (e.g., zinc sulfide, silicon monoxide) not adhere. Gold-coated mirrors that have undergone this type of overcoating process are known in the art as protected gold mirrors, and, in fact, tend to be comparatively more scratch resistant than conventional gold-coated mirrors. However, protected gold mirrors are even more expensive than conventional gold-coated mirrors.

A highly cost-effective alternative to gold-coated standard mirrors is to produce them using replication processes. The optical replication process is a well-established technology employed to produce high quality reflective mirrors. As contrasted to standard front-surface metal mirrors manufactured on expensive polished substrates, replicated mirrors are produced on comparatively lower quality inexpensive substrates and thereby offer a range of significant benefits. This includes: major cost-savings, the production of light weight/low inertia optics, high-volume repeatable manufacturability, the ability to create mirror surfaces on very complex and inaccessible surfaces, and the ability to produce monolithic structures (i.e. integrated optical mounts and assemblies with mirrored surfaces). Typical configurations include aspheric mirrors (on-and-off axis paraboloids, ellipsoids and toroids), monolithic hollow corner-cubes and roof prisms, flats and spheres. Typical substrate materials include: aluminum, beryllium, Pyrex and crown glass, fused silica, graphite epoxy, aluminum oxide, silicon, silicon carbide, titanium, stainless steel and plastics. Very high quality mirror surfaces are possible, oftentimes achieving λ/10 or better. Replication is an established technique employed to manufacture high-quality mirrors for such applications as: interferometry, analytical instrumentation and telecommunications.

Unfortunately, replicated gold mirrors, like conventional gold-coated mirrors, also suffer from being very soft, allowing them to become easily scratched upon cleaning. While various approaches exist for creating a protective overcoat on conventional metal mirrors, such has not been the case for replicated gold mirrors. As shown in FIG. 1, a replicated gold mirror 1 is formed by a master process and may be formed in any variety of shapes including, flats, arcuate shapes, cubes, saw-tooth profiled, and the like. The basic optical replication process begins with a high-quality “master” which is essentially identical to the required finished product with exactly the same specifications. Such “masters”, having very highly polished surfaces, may typically be produced from glass, nickel-coated stainless steel, or silicon carbide. Under vacuum, various materials are deposited upon the master surfaces using, most commonly, thermal evaporation techniques. A “release” layer may be the first thin film deposited upon the master, subsequently followed by the required reflective metal (gold) and binder (e.g. a layer of chrome). The coated master is then removed from the vacuum and subsequently coated with a suitable liquid epoxy adhesive. This is bonded to the chosen inexpensive substrate (the epoxy layer conforms to the optically-perfect master surface and the imperfect substrate). After this epoxy layer is fully cured, the master is carefully separated (“released”). The resultant exposed metal-mirror surface thereby duplicates the optical precision of the master. The final replicated mirror therefore consists of a multi-layer structure (FIG. 1): substrate (3), epoxy (5), binder (7) and final reflective gold (9).

The critical epoxy layer (5) of replicated gold mirrors generally has a softening point of about 125° C., which is well below the required temperature of about 300° C. required for current state-of-the-art overcoating processes. Thus, current overcoating processes would soften and degrade the epoxy layer 5 of the replicated mirror 1, potentially degrading or destroying the replicated mirror. Further, due to the very high optical precision of many replicated gold mirrors, an overcoating occurring at even slight elevated temperatures (>70° C.) may result in irreversible damage to the replicated mirror.

Thus, in light of the foregoing, there exists an ongoing need for protectively overcoated replicated gold mirrors.

### SUMMARY

The various devices and methods that are described in the present application meet these and other needs through overcoated replicated gold mirrors that are formed by a process that entails providing a replicated gold mirror (e.g., via a master process) and depositing, applying or otherwise placing an overcoat layer on the replicated gold mirror at a temperature up to about 25° C.

In one embodiment, the present application is directed to a replicated gold mirror having an overcoat applied thereto and includes a replicated gold mirror having at least one gold material layer applied to a replication layer, and at least one overcoat layer applied to the gold material layer at a temperature up to about 125° C.

In another embodiment, the present application is directed to an overcoated replicated gold mirror and includes a replicated gold mirror, and an overcoat layer formed of a metallic semiconductor and deposited on the replicated gold mirror at a temperature up to about 25° C., wherein the overcoated replicated gold mirror has a reflectivity of at least 85% within the entire range of about 1580 nm to about 15000 nm.

Additionally, the present application discloses a method of producing an overcoated replicated gold mirror and includes providing a replicated gold mirror, and depositing an overcoat layer onto the replicated gold mirror at a temperature up to about 25° C.

In another embodiment, the present application is directed to a method of manufacturing a replicated gold mirror and includes providing a substrate, forming at least one replication layer on the substrate, applying at least one binding agent to the replication layer, coupling at least one layer of gold material to the replication layer with the binding agent, and depositing at least one layer of overcoating material to the gold layer at a temperature up to about 25° C.

It is to be understood that both the foregoing general description and the following detailed description are merely illustrative examples of various overcoated replication gold mirrors and methods of their manufacture/formation, and are intended to provide an overview or framework for understanding the nature and character of the claimed subject matter. The accompanying drawings are included to provide a further understanding of the various embodiments of the overcoated replicated gold mirrors and such methods described herein, and are incorporated in and constitute a part of this specification.

### BRIEF DESCRIPTION OF THE DRAWINGS

For a fuller understanding of the nature and desired objects of the various embodiments of the overcoated replicated gold mirrors and methods of manufacture/formation as described herein, reference is made to the following detailed description, which is to be taken in conjunction with the accompanying drawing figures wherein any like reference characters denote corresponding parts throughout the several views presented within the drawing figures, and wherein:

FIG. 1 is a schematic front view of a conventional replicated gold mirror;

FIG. 2 is a schematic front view of an exemplary overcoated replicated gold mirror of the present application;

FIG. 3 is a schematic view of a conventional device usable to form the overcoat layer of the overcoated replicated gold mirror of FIG. 2;

FIG. 4 is a graph depicting the reflectivity of an exemplary overcoated replicated gold mirror of the type shown in FIG. 2; and

FIG. 5 is a graph depicting the reflectivity of an exemplary overcoated replicated gold mirror of the type shown in FIG. 2.

### DETAILED DESCRIPTION

The present application discloses various embodiments of replicated gold mirrors having at least one overcoat applied thereto and various methods of making overcoated replicated gold mirrors. The replicated gold mirrors of the present application are highly beneficial because they include an overcoat layer which reliably adheres to the underlying replicated gold mirror despite being applied thereto at a temperature less than or about equal to room temperature (i.e., at or below about 25° C.). Moreover, application of the overcoat layer at a temperature less than or about equal to room temperature will not damage an adhesive layer of the replicated gold mirror, which can be present if the replicated gold mirror was formed via a master process, and which necessarily and disadvantageously is ruined (e.g., melted or deformed) during conventional, high temperature (e.g., 300° C. or above) processes typically used for overcoating standard gold mirrors. In another embodiment, the overcoat layer may be applied to the replicated gold mirror at a temperature greater than room temperature, but less than about 130° C., far below the temperature often encountered using conventional, high temperature coating processes.

FIG. 2 shows an embodiment of a replicated gold mirror having at least one overcoat applied thereto. As shown, the replicated mirror 20 comprises a substrate 22 having one or more replication layers applied thereto. The substrate 22 may be manufactured from any variety of materials, including, without limitation, glass, polymers, silicon, titanium, aluminum, stainless steel, composite materials, ceramic, glass composites, aerogels, and the like. Further, any variety of materials may be used to form the bonding layer 24, including, without limitation, epoxies, glues, polymers, silicon, elastomers, and the like. In one embodiment, the bonding layer 24 comprises an Epo-Tek 301, an optical epoxy commercially available from Epoxy Technology of Billerica, Mass. Referring again to FIG. 2, one or more binding agents 26 may be applied to the replicated mirror layer 28. In one embodiment, the binding agent 26 is configured to help ensure that one or more reflecting materials 28 will adhere well to the bonding layer 24. Any variety of binding agents 26 may optionally be used, including, without limitation, chrome, nickel, titanium and the like. It is noted that the high-precision master employed to create the binder 26 and mirror layer 28 may be configured to replicate any desired profile. For example, the replicated layers 26 and 28 may be configured to form a saw-tooth profile, arcuate profile, a corner cube, and the like.

As shown in FIG. 2, one or more layers of a reflective material may be applied to the applied to the substrate 22. In the illustrated embodiment, the reflective layer of gold 28 is adhered to the bonding layer 24 via the binding agent 26. Those skilled in the art will appreciate that any variety of reflective materials may be used, including, without limitation, silver, copper, aluminum, alloys, and the like. Thereafter, at least one layer of overcoating layer 30 is formed on the reflective gold mirror layer 28 to form an overcoated replicated gold mirror 20. In one embodiment, the gold mirror 20 has a reflectivity of at least 70% within the range of wavelengths of about 1300 μm to about 15000 nm. For example, in one embodiment the gold mirror has a reflectivity of at least 85% within a range of wavelengths from about 1580 nm to about 15000 nm. In another embodiment, the gold mirror 20 has a reflectivity of about 95% to about 98% within a range of wavelengths from about 3500 nm to about 15000 nm. In another embodiment, the gold mirror has a reflectivity of at least 96% within a range of wavelengths from about 1300 nm to about 1700 nm.

Referring again to FIG. 2, in one embodiment, the overcoating material 30 comprises a hard, protective, scratch/abrasion resistant overcoat, although those skilled in the art will appreciate that the overcoating material 30 may be used for any variety of purposes. In the illustrated embodiment, the overcoating material 30 comprises silicon. In another embodiment, the overcoating material 30 comprises germanium. Optionally, the overcoating material 30 may comprises a metallic, semiconductor materials. Optionally, the overcoating material 30 may comprise multiple materials. For example, the overcoating material 30 may comprise alternating layers of a first and second material. Exemplary materials include, without limitation, various metallic oxides, silicon dioxide, magnesium fluoride, aluminum oxide, and the like. The overcoating material 30 may be applied in any variety or desired thicknesses. For example, in one embodiment the overcoating material 30 has a thickness of about 70 nm to about 160 nm.

Those skilled in the art will appreciate that the any variety of overcoating materials may be used to form the overcoating layer, yet also to be able to reliably adhere to the layer of gold mirror material 28 despite being applied at or below room temperature (i.e., 25° or below) so as not to melt or otherwise damage the bonding layer 24. In one embodiment, metallic semiconductor material (e.g., silicon or germanium) serves these purposes when selected as the material from which the overcoat layer 30 is formed.

The replicated gold mirrors disclosed herein may be manufactured in any variety of ways. However, unlike prior art manufacturing methods, the overcoating material 30 may be applied to the gold mirror 20 at a temperature less than of approximately equal to room temperature, thereby preserving the replicated characteristics of the mirror. Despite being formed at or below room temperature, the overcoat layer 30 of an overcoated replicated gold mirror 20 of the present application is hard and durable, and thus can adequately protect the reflective surface(s) of a replicated gold mirror from abrasion or scratching damage, which could otherwise occur when the mirror is cleaned (e.g., to remove contaminants). Further, the presence of the overcoat layer 30 does not detract from the overall ability of the replicated gold mirror to be essentially fully reflective within the range of about 800 nm to about 15000 nm. For example, the replicated gold mirror 20 (See FIG. 2) disclosed herein is essentially fully reflective (i.e. reflectivity of 97% or greater) in the wavelength range of about 1300 nm to about 15000 nm. Individually and collectively, these benefits enable production of comparatively less expensive, yet well performing, highly reliable and long lasting overcoated replicated gold mirrors that can be used in any replicated or non-replicated gold mirror application, even those in which harsh environmental conditions are routinely encountered.

To form an overcoated replicated gold mirror in accordance with the present application, a replicated gold mirror not having an overcoat layer is produced using various methods known in the art. As stated above, the replicated gold mirror may be formed in any variety of shapes or configuration, including, for example, saw-tooth profiled, arcuate, curves, intersecting planes, forming a corner cube, and the like. In one embodiment, the replicated gold mirror is formed using a master process known in the art. Thereafter, a quantity of a metallic semiconductor is deposited directly onto the layer of gold mirror material 28 via a reactive ion plating deposition process to form the overcoat layer 30 of the overcoated replicated gold mirror 20. In the illustrated embodiment, the overcoating material 30 is applied to the gold material 28 using a reactive ion plating process at or below room temperature (i.e., about 25° C. or below). Further, the ion plating coating procedure may be configured to provide a overcoat layer 30 having a uniform thickness independent of surface morphology; is isotropic; is physically and optically permanent; is amorphous and structure-less in all directions; and is substantially invariant upon exposure to a wide range of temperatures and humidities. Moreover, the overcoat layer 30 deposited via reactive ion plating is fully densified, and thus does not absorb atmospheric moisture that would otherwise disadvantageously cause optical absorption to occur in the range of about 2600 nm to about 2900 nm, which falls within the about 800 nm to about 15000 nm reflective range required for at least some applications (e.g., air quality testing) of replicated gold mirrors. Further, the overcoat layer 30 deposited via reactive ion plating does not suffer from any of the one or more disadvantages (e.g., porosity, lack of hardness, poor adhesion, microcracking) that tend to plague overcoat layers applied to standard front-surface gold mirrors in accordance with conventional overcoating processes. However, those skilled in the art will appreciate that the overcoating material 30 may be applied at or about room temperature in any variety of ways.

FIG. 3 shows an embodiment of an apparatus useful in overcoating a replicated gold mirror, wherein this apparatus 50 also is described in U.S. Pat. No. 6,139,968, the entirety of which is incorporated by reference herein. As shown, the apparatus 50 includes at least one evacuatable overcoating vessel 52 and at least one evacuation/vacuum apparatus 54 in communication with and provides a vacuum to the vessel 52. The apparatus 50 further includes at least one deposition plasma source 56 and one or more electron beam guns 58 for supplying electrons of energy directed towards at least one containment structure 60, which houses one or more overcoating materials 62 to be utilized to form the overcoat layer 30 (See FIG. 2).

An exemplary overcoating apparatus 50 is the BAP 800 Batch Ion Plating System, which is commercially available from Evatec LTD of Flums, Switzerland, wherein the vacuum system 54 can be any system currently, formerly or hereafter known to one of ordinary skill the art, such as an oil diffusion pump with a Roots Blower. The containment structure 60 can have a range of shapes and sizes, and may be constructed of a number of suitable materials, wherein such choices can depend on various factors including but not limited to the specific overcoating material 62 that is to be contained therein. By way of non-limiting example, the containment structure 60 may be a copper crucible, which may include a molybdenum liner.

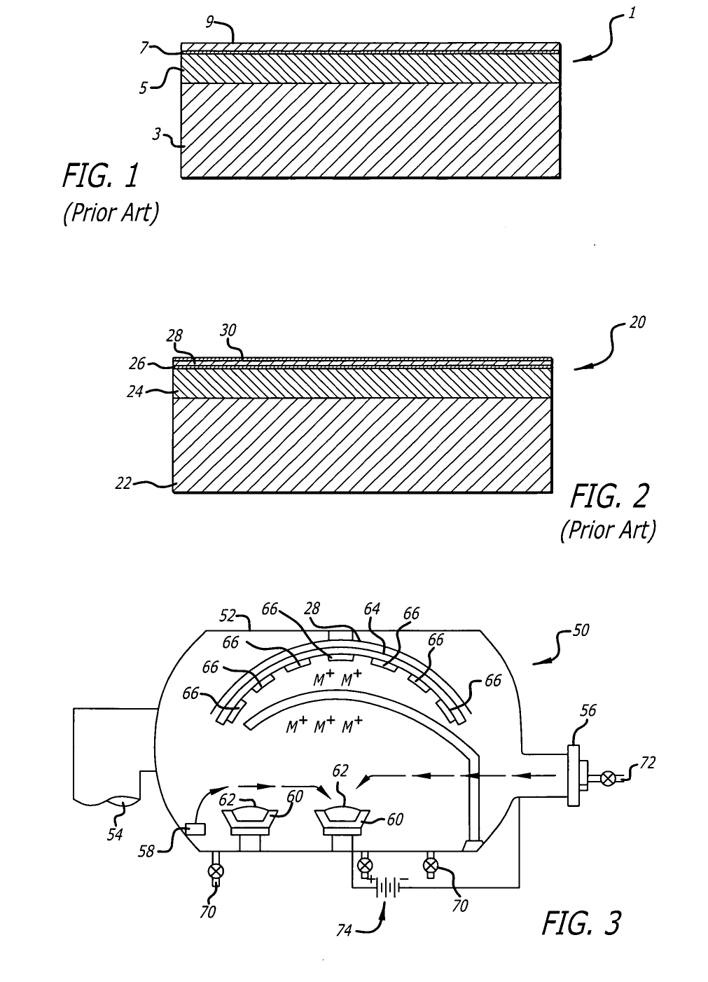

The overcoating apparatus 50 further includes a support structure 64, which is positioned opposite the containment structure 50, and which, during the overcoating process, holds one or more replicated gold mirrors 66 (i.e., one or more non-overcoated replicated gold mirrors 100 as shown in FIG. 1) onto which overcoating material 62 is to be deposited/applied as a overcoat layer 30 (See FIG. 2). By way of non-limiting example, the electrically insulated support structure 64 can be a rotating, elongate, dome-shaped structure that is suspended from the ceiling of the coating vessel 52 as is generally known in the art. It should be noted, however, that the support structure 64 may be differently configured as well; for example, it may have a substantially flat surface or it may be substantially cone-shaped. Also by way of non-limiting example, each of the one or more non-overcoated replicated gold mirrors 66 is cleaned prior to being loaded into the coating vessel 52 of the apparatus 50. By way of non-limiting example, such cleaning can be accomplished mechanically (e.g. ultrasonically in non-ionic detergent) or chemically (e.g., through the use of one or more organic solvents).

One or more feedlines 70 act as gas sources and allow for the introduction of gas during deposition/application of the overcoating material 62. Specifically, one or more feedlines 70 discharge a gas (e.g., argon) at a position proximate to the containment structures 60 such that an effective density of the gas (e.g., argon) can mix and react with material vaporized from the containment structure 60 during the reactive ion plating overcoating process. Those skilled in the art will appreciate that any variety of gases may be introduced into to the containment vessel 52 via the feedline 70.

To deposit an overcoating layer 30 (See FIG. 2) on a replicated gold mirror 20 in accordance with the present application, the coating vessel 52 is evacuated by the vacuum system 54 in order to cause the coating vessel to have a base vacuum pressure of less than about 3×10⁻⁶ mbar. An electron beam source 58 (e.g., a 270° electron beam gun) of a deposition plasma source 56 is employed to supply electrons of energy during the overcoating process. In use, the electron beam gun 58 directs an intense electron beam into the containment structure 50 to vaporize the overcoating material 62 contained therein. The deposition plasma source 56 also generally, but not necessarily, includes a heated tantalum filament and a gas inlet 72 and is connected to the electrically conductive containment structure 50 through a low voltage, high current power supply 74.

As a result of the deposition plasma discharge that is operated during the overcoating process, the one or more non-overcoated replicated gold mirrors 66 positioned on the support structure 64 become negatively self-biased and the vaporized overcoating material 52 (which is denoted by M⁺ in FIG. 3) that is activated by the deposition plasma becomes highly energetic, ionized and chemically reactive. The energized material M⁺ is attracted to the one or more non-overcoated replicated gold mirrors 66 via electromagnetic coulomb attraction, after which overcoating deposition/application occurs. All of these various steps of the overcoating process are performed or can be performed at or below room temperature (i.e., 25° C. or below).

It is understood that the apparatus 50 may further include one or more additional auxiliary devices (e.g., auxiliary coils for the production of magnetic fields, etc.), each of which is generally known in the art. It is further understood that, if desired, the overcoating process described herein can be utilized to apply or deposit an overcoat layer onto a non-replicated gold mirror (e.g., a protected gold mirror) or to apply or deposit an overcoat layer onto a replicated or non-replicated mirror made of any other metal, e.g. an aluminum mirror or a silver mirror.

Thus, in accordance with an exemplary reactive ion plating overcoating process using the apparatus 50 of FIG. 3, plasma-supported reactive evaporation of the overcoating material 62 occurs under low pressure via an electron beam supplied by an electron beam gun 58. This causes the non-overcoated replicated gold mirror 66 to obtain a negative electrical charge and the vaporized overcoating material 62, which is in the form of positively charged ions, to be directed toward and ultimately condensed as an overcoat layer 30 (see FIG. 2) on the gold mirror material 28 adhered to the substrate 24 (see FIG. 2) so as to form the overcoated replicated gold mirror 20 shown in FIG. 2. The resulting overcoat layer 30 has high energy (e.g., on the order of about 20 eV to about 100 eV) due to the electromagnetic attraction between the ionized coating material 62 and the negatively biased non-overcoated replicated gold mirror 66.

### EXAMPLES

Two exemplary overcoated replicated gold mirrors 20 of the type shown in FIG. 2 were produced through use of the above-described reactive ion plating process employing the apparatus shown in FIG. 3. In both examples the overcoat layer 30 was formed of silicon; however, the thickness of the overcoat layer in the first example was about 70 nm, whereas its thickness in the second example was about 160 nm. It should be noted that in accordance with the present invention the thickness of the overcoat layer can be below 70 nm, above 160 nm, or with the range of about 70 nm to about 160 nm (and all subranges therebetween), wherein the exact thickness is chosen based factors such as the range of infrared wavelength sought to be reflected by the overcoated replicated gold mirror 20.

To form the two exemplary gold mirrors 300, a quantity of metallic silicon was loaded into the containment structure 60 of the coating vessel 52 of the apparatus 50. The following conditions were present in the apparatus 50 during the overcoating process: the deposition plasma gas pressure within the plasma source 56 was about 2.8 mbar; the plasma voltage was in the range of about 55 volts to about 60 volts; the plasma current was in the range of about 70 amps to about 80 amps; the anode-to-ground voltage was about 40 volts; the plasma filament current was about 110 amps; the reactive gas was argon, which was introduced through feedline(s) 70; the reactive gas pressure within the coating vessel 52 was about 1.2×10⁻³ mbar; and the electron beam gun(s) 58 for reagent evaporation were operated at a voltage of about 10 kV, an emission of about 400 mA and at a rate of about 0.25 nm/second. These and other conditions are summarized in Table 1 below.

TABLE 1

| | |
|---|---|
| Overcoating Material | Silicon |
| Containment structure material | Copper |
| Plasma gas (pressure) | Argon (about 2.8 mbar within plasma |
| Reactive gas (pressure) | Argon (about 1.2 × 10⁻³ mbar within |
| | coating vessel) |
| Anode-to-Ground voltage | about 37 V |
| Arc voltage | about 55 V to about 60 V (e.g., |
| | about 55 V) |
| Ground voltage | about 40 V |
| Arc current | about 70 A to about 80 A (e.g., |
| | about 75 A) |
| Plasma filament current | about 110 A |
| Hold power | about 22.0% |
| Electron beam voltage | about 10 kV |
| Electron beam emission | about 400 mA |
| Electron beam deposition rate | about 0.25 nm/second |
| Electron Beam Power (Ramp 1) | 20 seconds at about 38% power |
| Electron Beam Power (Ramp 2) | 40 seconds at about 46% power |
| Electron Beam Power (Ramp 3) | 40 seconds at about 51% power |
| Process temperature | 25° C. or below |

To evaluate the scratch/abrasion resistance of the two exemplary overcoated replicated gold mirrors 20, each was separately subjected to a moderate abrasion test pursuant to military specification MIL-F-48616. After 500 strokes, neither exemplary overcoated replicated gold mirror 20 demonstrated any discernable surface changes, let alone any surface scratching of the type that would affect reflectivity. Thus, overcoated replicated gold mirrors 20 produced in this manner would be able to resist scratching even after repeated surface cleanings, which could be necessary if, as often can occur, the overcoated replicated gold mirror 20 was to become contaminated with dirt, dust, oil or debris due to being used in inclement weather and/or in an environment with polluted air.

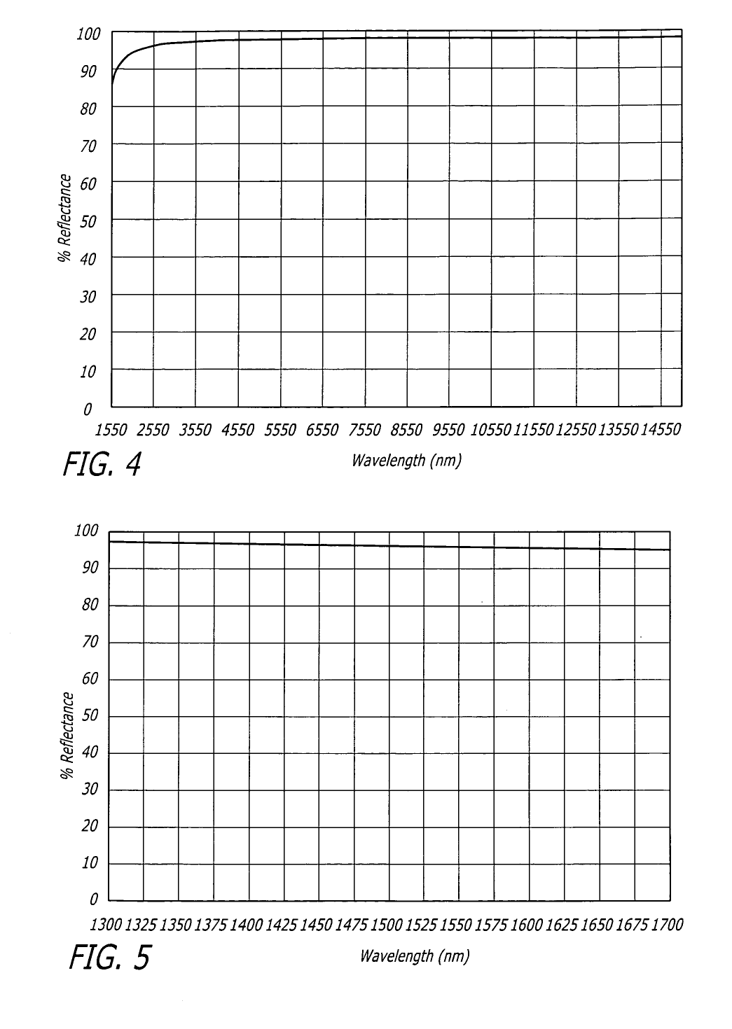

FIGS. 4 and 5 graphically show the spectral performance of the two exemplary overcoated replicated gold mirrors 20. Specifically, FIG. 4 shows the spectral performance of the overcoated replicated gold mirror 20 that includes an overcoat layer 30 of silicon having a thickness of about 70 nm, whereas FIG. 5 shows the spectral performance of the overcoated replicated gold mirror 20 that includes an overcoat layer 30 of silicon having a thickness of about 160 nm.

As shown in FIG. 4, the exemplary overcoated replicated gold mirror 20 with an overcoat layer 30 of silicon having a thickness of about 70 nm has a reflectivity above about 85% within the entire range of about 1580 nm to about 15000 nm (and within all subranges therebetween), and a reflectivity of about 95% to about 98% within the entire range of about 3500 nm to about 15000 nm (and all subranges therebetween). Therefore, an overcoated replicated gold mirror 20 that includes an overcoat layer 30 of silicon having a thickness of about 160 nm is well suited for various applications such as testing and/or monitoring the environment for the presence of certain air pollutants (e.g., carbon monoxide, carbon dioxide, nitrogen oxides and sulfur oxides), each of which produces an optical absorption peak within the range of about 1580 nm to about 15000 nm.

As shown in FIG. 5, the overcoated replicated gold mirror 20 with an overcoat layer 30 of silicon having a thickness of about 160 nm has a reflectivity of about 98% within the entire range of about 1300 nm to about 1700 nm (and all subranges therebetween). Therefore, an overcoated replicated gold mirror 20 that includes an overcoat layer 30 of silicon having a thickness of about 70 nm is well suited for various applications such as testing and/or monitoring the environment for the presence of certain air pollutants (e.g., hydrofluoric acid, hydrogen chloride, hydrogen sulfide, ammonia, methane, hydrogen cyanide, ethylene and acetylene), each of which produces an optical absorption peak within the range of about 1300 nm to about 1700 nm.

Although aspects of the present application have been described herein with reference to details of currently preferred embodiments, it is not intended that such details be regarded as limiting the scope of the invention, except as and to the extent that they are included in the following claims—that is, the foregoing description of the embodiments of the optical filters of the present application are merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

1. An overcoated replicated gold mirror, comprising:
a replicated gold mirror having at least one gold material layer applied to at least one replication layer using at least one binding agent; and
at least one overcoat layer applied to the gold material layer at a temperature up to about 125° C.

2. The overcoated replicated gold mirror of claim 1, wherein the overcoat layer is formed of a metallic semiconductor.

3. The overcoated replicated gold mirror of claim 2, wherein the overcoat layer is formed of silicon.

4. The overcoated replicated gold mirror of claim 2, wherein the overcoat layer is formed of germanium.

5. The overcoated replicated gold mirror of claim 1, wherein the replicated gold mirror is produced via a master process.

6. The device of claim 1 wherein the replication layer is coupled to a substrate.

7. The device of claim 1 wherein the replicated gold mirror is arcuate.

8. The device of claim 1 wherein the replicated gold mirror includes a saw-tooth profile.

9. The device of claim 1 wherein the replicated gold mirror forms a corner cube.

10. The overcoated replicated gold mirror of claim 1, wherein the overcoat layer has a thickness in the range of about 70 nm to about 160 nm.

11. The overcoated replicated gold mirror of claim 1, wherein the overcoated replicated gold mirror has a reflectivity of at least 85% within the entire range of about 1580 nm to about 15000 nm.

12. The overcoated replicated gold mirror of claim 1, wherein the overcoated replicated gold mirror has a reflectivity of about 95% to about 98% within the entire range of about 3500 nm to about 15000 nm.

13. The overcoated replicated gold mirror of claim 1, wherein the overcoated replicated gold mirror has a reflectivity of about 98% within the entire range of about 1300 nm to about 1700 nm.

14. The device of claim 1 wherein the at least one overcoat layer applied to the gold material layer at a temperature up to about 75° C.

15. The device of claim 1 wherein the at least one overcoat layer applied to the gold material layer at a temperature up to about 25° C.

16. An overcoated replicated gold mirror, comprising:
a replicated gold mirror; and
an overcoat layer formed of a metallic semiconductor and deposited on the replicated gold mirror at a temperature up to about 25° C., wherein the overcoated replicated gold mirror has a reflectivity of at least 85% within the entire range of about 1580 nm to about 15000 mm.

17. The overcoated replicated gold mirror of claim 16, wherein the metallic semiconductor is selected from the group consisting of silicon and germanium.

18. A method of producing an overcoated replicated gold mirror, comprising:
providing a replicated gold mirror;
depositing an overcoat layer onto the replicated gold mirror at a temperature up to about 25° C.

19. The method of claim 18, wherein the overcoat layer is formed of a metallic semiconductor.

20. The method of claim 19, wherein the overcoat layer is formed of silicon.

21. The method of claim 19, wherein the overcoat layer is formed of germanium.

22. The method of claim 18, wherein the step of providing a replicated gold mirror is accomplished via a master process.

23. The method of claim 18, wherein the overcoat layer has a thickness in the range of about 70 nm to about 160 nm.

24. The method of claim 18, wherein the overcoated replicated gold mirror has a reflectivity of at least 85% within the entire range of about 1580 nm to about 15000 nm.

25. The method of claim 18, wherein the overcoated replicated gold mirror has a reflectivity of about 95% to about 98% within the entire range of about 3500 nm to about 15000 nm.

26. The method of claim 18, wherein the overcoated replicated gold mirror has a reflectivity of about 98% within the entire range of about 1300 nm to about 1700 nm.

27. A method of manufacturing a replicated gold mirror, comprising:
providing a substrate;
forming at least one adhesive layer on the substrate;
applying at least one binding agent to the replication layer;
coupling at least one layer of gold material to the replication layer with the binding agent; and
depositing at least one layer of overcoating material to the gold layer at a temperature up to about 25° C.

28. The method of claim 27 wherein the overcoat layer has a thickness in the range of about 70 nm to about 160 nm.
